(19) United States
(12) Patent Application Publication
(10) Pub. No.: US 2026/0076448 A1
(43) Pub. Date: Mar. 19, 2026

(54) SOLE STRUCTURE FOR A SHOE

(71) Applicant: MIZUNO Corporation, Osaka-shi (JP)

(72) Inventors: Kenjiro KITA, Osaka-shi (JP); Natsuki SATO, Osaka-shi (JP); Takao ODA, Osaka-shi (JP)

(21) Appl. No.: 19/318,473

(22) Filed: Sep. 4, 2025

(30) Foreign Application Priority Data
Sep. 13, 2024 (JP) 2024-159590

(51) Int. Cl. A43B 13/26; A43B 23/02; B29C 64/118; B29L 31/50; B33Y 80/00

(52) U.S. Cl. CPC A43B 13/26; A43B 23/0245; B33Y 80/00; B29C 64/118; B29L 2031/504

(57) ABSTRACT

The sole structure for a shoe further increases grip performance. The sole structure includes a longitudinally extending sole body. The sole body has a plurality of columnar portions provided at the lower surface of the sole body. The bottom surface of the respective columnar portions has a ground-contact surface. The outer circumferential surface of the respective columnar portions has a plurality of protrusions that protrude laterally.

### BACKGROUND OF THE INVENTION

The present invention relates generally to a sole structure for a shoe, and more particularly, to an improvement of the sole structure for increasing grip performance.

Japanese patent application publication 2021-79610 describes in paragraphs [0028], [0040] and FIG. 21 a sole for an article of footwear in which multiple columnar protrusions (20 bp) are provided at the lower surface of the sole. According to such a sole, not only anti-slip properties and grip properties at the ground-contact surface can be improved but also the area of the entire ground contact surface can be enlarged and landing stability can be enhanced.

However, a further improvement of the grip performance is required in the sole for a shoe. From that point of view, the development of the sole has been desired.

The present invention has been made in view of these circumstances and its object is to provide a sole structure for a shoe that can further improve grip performance

Other objects and advantages of the present invention will be obvious and appear hereinafter.

### SUMMARY OF THE INVENTION

A sole structure for a shoe according to the present invention comprises a longitudinally extending sole body. The sole body includes a plurality of columnar portions provided at a lower surface of the sole body. The bottom surface of the columnar portions has a ground-contact surface and the outer circumferential surface of the columnar portions has a plurality of laterally extending protrusions.

According to the present invention, when the shoe impacts the ground, plural columnar potions provided at the lower surface of the sole body come into contact with the ground. At this time, the ground-contact surface at the bottom surface of the respective columnar portions exerts grip performance. Also, due to a load applied to the columnar portions at the time of contacting the ground, when the columnar portions tilt, the protrusions provided at the outer circumferential surface of the columnar portions come into contact with the ground. At this juncture, due to the action of the protrusions, grip performance during contact with the ground can be further improved.

At the time of loading, the columnar portions may tilt such that the protrusions contact the ground.

The plurality of protrusions may be provided axially and circumferentially at the proximal-end side to the distal-end side of the columnar portions.

The distal end of the protrusions may have a corner with an edge.

The upper surface of the sole body may constitute a foot-sole-contact surface that a foot sole of a shoe wearer contacts directly or indirectly through an insole. The sole body may have functions as both a midsole that imparts cushioning properties to a foot of the shoe wearer and an outsole that contacts the ground.

The sole body may be integrally formed with the columnar portions and the protrusions.

The sole structure may be formed by an additive manufacturing through a 3D printer.

The 3D printer may be a fused-deposition-modeling type.

As mentioned above, according to the sole structure of the present invention, grip performance can be further improved.

### BRIEF DESCRIPTION OF THE DRAWINGS

For a more complete understanding of the invention, reference should be made to the embodiments illustrated in greater detail in the accompanying drawings and described below by way of examples of the invention.

FIG. 1 is a general perspective view of a shoe employing the sole structure according to the present invention.

FIG. 2 is a side view of the shoe of FIG. 1.

FIG. 3 is a rear elevational view of the shoe of FIG. 1.

FIG. 4 is a bottom plan view of the shoe of FIG. 1.

FIG. 5 is a top plan schematic view of an example of a basic module of a resin-fiber-made three-dimensional elastic structure that constitutes the sole structure of FIG. 1.

FIG. 5A is a top plan schematic view of an example of a first pattern that is arranged at a topmost layer (or a first layer) of the basic module of FIG. 5.

FIG. 5B is a top plan schematic view of an example of a second pattern that is arranged at a second layer immediately below the first layer of the basic module of FIG. 5.

FIG. 5C is a top plan schematic view of an example of a third pattern that is arranged at a third layer immediately below the second layer of the basic module of FIG. 5.

FIG. 5D is a top plan schematic view of an example of a fourth pattern that is arranged at a fourth layer immediately below the third layer of the basic module of FIG. 5.

FIG. 6 is a longitudinal sectional view of a portion of the sole body and the columnar portions of the sole structure of FIG. 1, corresponding to a cross-sectional view of FIG. 7 taken along line VI-VI.

FIG. 7 is a cross-sectional view of FIG. 6 taken along line VII-VII.

FIG. 8 is a schematic illustrating the deformation of the sole body of FIG. 6 when the load is applied.

FIG. 9 is a schematic illustrating the deformation of the sole body of FIG. 6 when the load is applied.

FIG. 10 shows a first alternative embodiment of FIG. 6, which corresponds to a cross-sectional view of FIG. 11 taken along line X-X.

FIG. 11 is a cross-sectional view of FIG. 10 taken along line XI-XI.

FIG. 12 is a schematic illustrating the deformation of the sole body of FIG. 10 when the load is applied.

FIG. 13 is a schematic illustrating the deformation of the sole body of FIG. 10 when the load is applied.

FIG. 14 shows a second alternative embodiment of FIG. 6, which corresponds to a cross-sectional view of FIG. 15 taken along line XIV-XIV.

FIG. 15 is a cross-sectional view of FIG. 14 taken along line XV-XV.

### DETAILED DESCRIPTION OF THE PREFERRED EMBODIMENTS

The present invention will now be described in detail with reference to embodiments thereof as illustrated in the accompanying drawings.

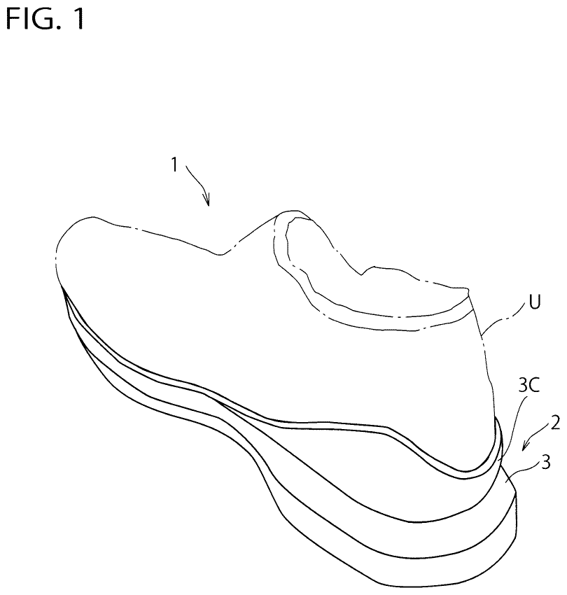

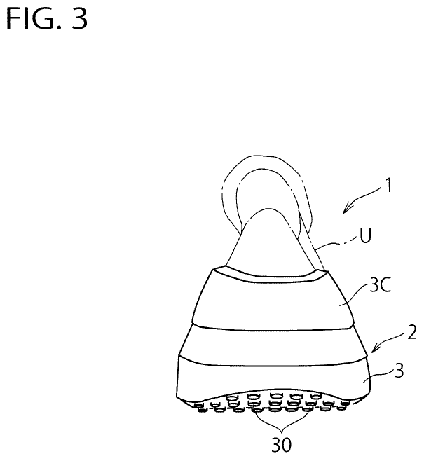

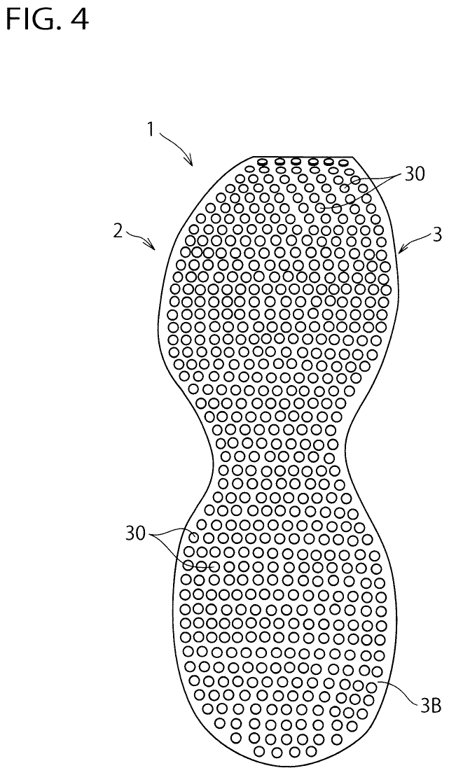

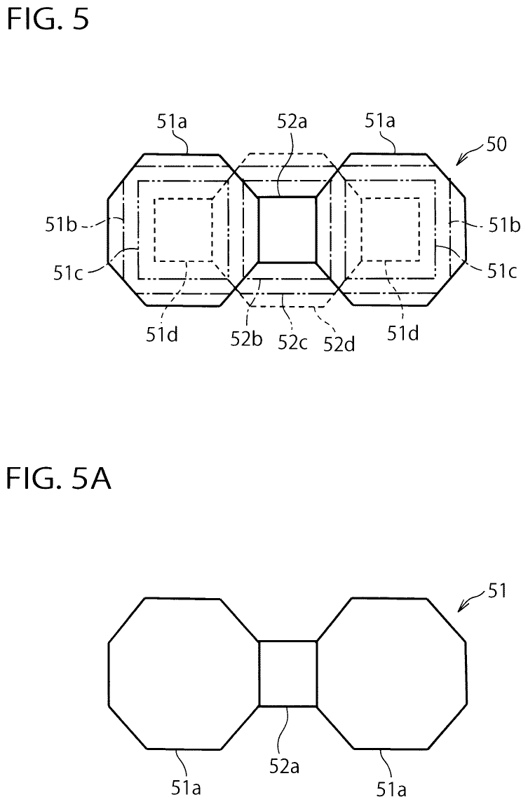

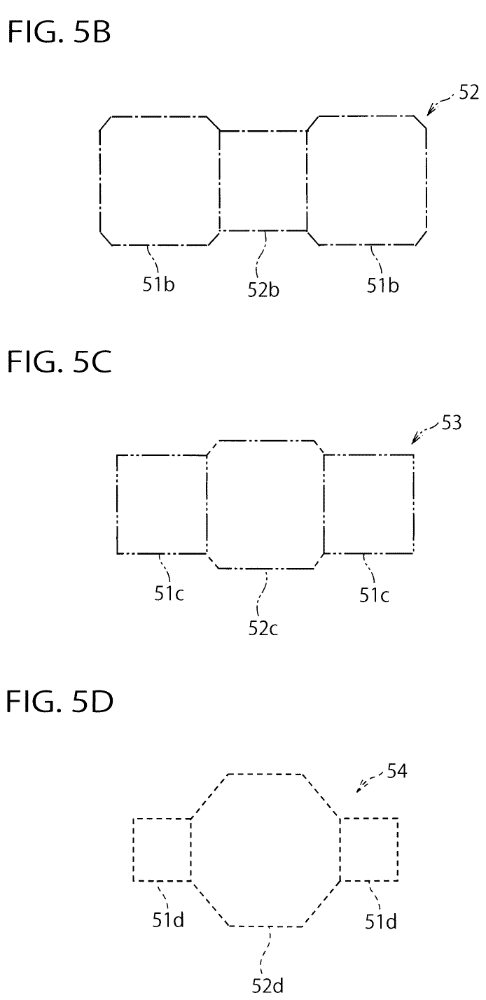

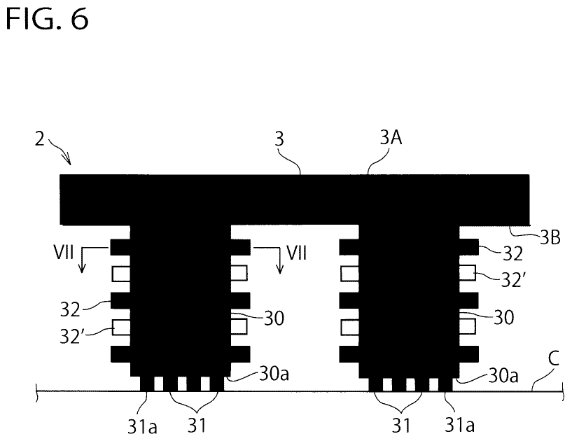

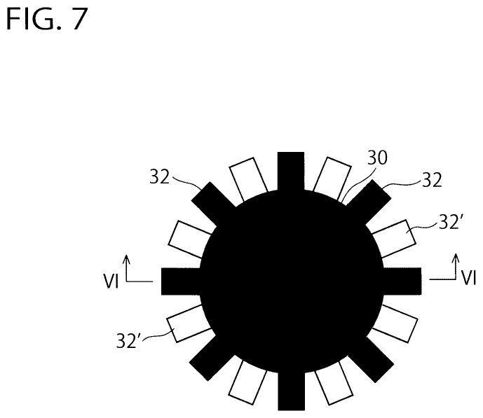

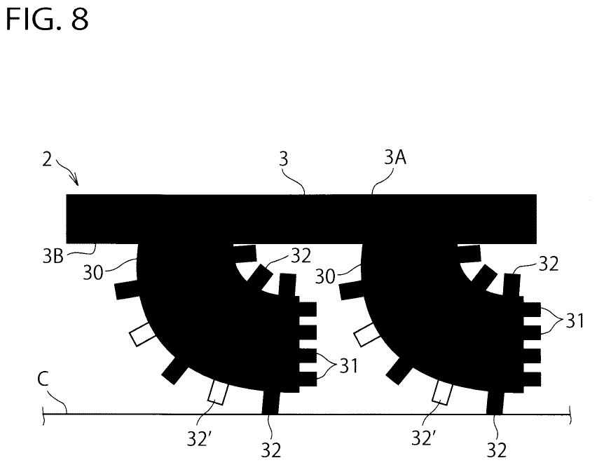

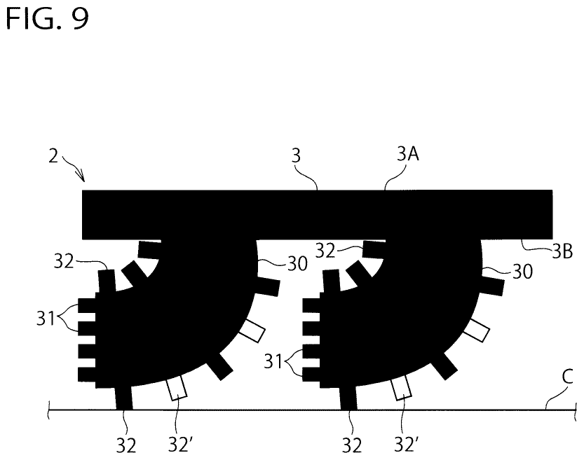

FIGS. 1 to 9 show a sole structure for a shoe according to an embodiment of the present invention and the shoe incorporating such a sole structure. In these drawings, FIGS. 1 to 4 illustrate an external appearance of the shoe employing the present embodiment; FIGS. 5 to 5D show an example of a basic module of a three-dimensional elastic fiber structure (or 3D filament structure) that constitutes the sole structure; FIG. 6 shows a longitudinal sectional view (i.e. a cross-sectional view of FIG. 7 taken along line VI-VI) of columnar portions provided at the sole body and the lower surface thereof; FIG. 7 shows a cross-sectional view of the columnar portions (i.e. a cross-sectional view of FIG. 6 taken along line VII-VII); and FIGS. 8 and 9 show the function of the columnar portions.

Here, a running shoe is taken for example as a shoe. In the following explanation (the same is applicable to the following first to sixth variants), “upward (upper side/upper)” and “downward (lower side/lower)” designate an upward direction and a downward direction, or vertical direction, of the shoe, respectively, “forward (front side/front)” and “rearward (rear side/rear)” designate a forward direction and a rearward direction, or longitudinal direction, of the shoe, respectively, and “a width or lateral direction” designates a crosswise direction of the shoe.

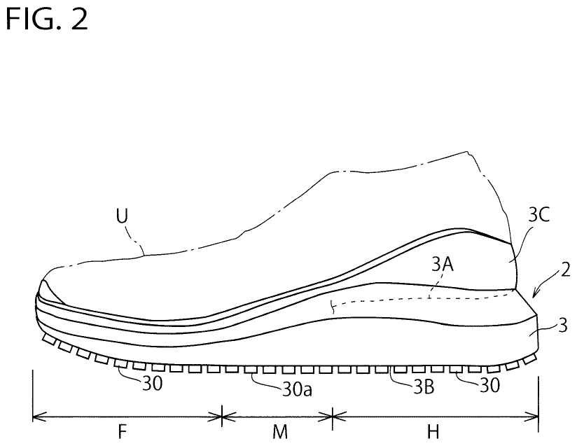

For example, in FIG. 2, a side schematic view of the shoe, “upward” and “downward” designate “upward” and “downward” in FIG. 2, respectively, “forward” and “rearward” designate “right to left direction” in FIG. 2, and “a width direction” designates “out of the page” and “into the page” of FIG. 2, that is, “a perpendicular direction to the sheet”.

As shown in FIGS. 1 to 4, Shoe 1 of the present embodiment comprises a sole structure 2 that extends longitudinally along the entire length of the sole 1 and an upper U (see a dash-and-dot line) that is provided on the shoe structure 2 and that covers a foot of a shoe wearer.

The sole structure 2 includes a sole body 3 that extends longitudinally. The sole body 3 has a heel region H, a midfoot region M and a forefoot region F that respectively correspond to a heel portion, a plantar arch portion, and a forefoot portion of the foot of the wearer. The sole body 3 has a foot-sole contact surface 3A (shown in part a dotted line) at a top surface thereof that a foot sole of the shoe wearer comes into direct contact with or indirect contact with through an insole (not shown) and the like. The foot-sole contact surface 3A forms a curved surface that gently curves in the longitudinal direction along the shape of the foot sole of the wearer.

A heel counter portion 3C extending along the perimeter of the heel region H is provided above the sole body 3 primarily at the heel region H of the sole body 3. The heel counter portion 3C rises upwardly from the foot-sole contact surface 3A of the sole body 3 to encompass and support the perimeter of the heel portion of the foot of the wearer. The shoe 1 is manufactured by fixedly attaching the bottom portion of the upper U with the foot-sole contact surface 3A and the heel counter portion 3C by gluing and the like.

At the lower surface 3B of the sole body 3, there is provided a plurality of columnar portions 30 (Details will be described below) that extends in the substantially up-down direction. Here, the reason why the term “substantially” is introduced is as follows:

If the lower surface 3B of the sole body 3 has a planar shape that extends longitudinally, it can be said that the columnar protrusions 30 extending below from the planar lower surface 3B extend in the up-down direction or vertically. However, the lower surface 3B of the sole body 3 is not necessarily planar-shaped in the longitudinal direction. For example, as shown in this example, the lower surface 3B may have a convexly curved shape that curves upwardly at a heel rear end and a toe portion. In such a case, the columnar portions 30 at the heel rear end and the toe portion extend diagonally to the up-down or vertical direction. Therefore, the term “substantially (up-down direction)” is used to include such an example.

The sole body 3 is integrally formed with the columnar portions 30 (in this example, also with the heel counter portion 3C). Also, the sole body 3 is formed of three-dimensional elastic structure along with the columnar portions 30 (also with the heel counter portion 3C).

Three-dimensional elastic structure can be made by various kinds of manufacturing methods. For example, in addition to FDM (Fused Deposition Modeling) in which molten resin is extruded through a nozzle for molding, SLS (Selective Laser Sintering) in which laser is radiated to sinter powdered material for molding, and CLIP (Continuous Liquid Interface Production) in which ultraviolet light is radiated to liquid resin for curing are used but the manufacturing method is not limited to these methods. Therefore, the three-dimensional elastic structure may be three-dimensional lattice structure and the like in addition to the 3D filament structure formed of resin filament. Also, the three-dimensional elastic structure may not be a box structure which is surrounded on all sides by a wall portion.

In this embodiment, the three-dimensional elastic structure is molded (or formed/3D-printed) by an additive manufacturing through a 3D printer. As such a 3D printer, an FDM (Fused Deposition Modeling) method type is preferably used. This method uses thermoplastic resin such as nylon, polyester, TPU (thermos-plastic polyurethane), PU (polyurethane), thermoplastic elastomer and the like, or rubber and the like. Also, in this embodiment, the three-dimensional elastic structure is a 3D filament structure in which a number of unidirectionally extending first resin filaments are arranged along a first direction and spaced apart in parallel on a horizontal plane and a number of unidirectionally extending second resin filaments intersecting with the first resin filaments are arranged along a second direction and spaced apart in parallel on the horizontal plane to form one resin layer on the horizontal plane, and such a resin layer is then overlayed in the vertical direction through a small clearance to form a multiple of resin layers.

According to such a three-dimensional elastic structure, due to not only elasticity of the resin fiber itself but also the small clearance between the respective resin layers vertically adjacent to each other, cushioning properties in the up-down direction can be exhibited. Therefore, the use of wear-resistant resin fiber for example can achieve a sole structure which is superior not only in cushioning and stability but also in durability such as wear-resistance, etc. and grip performance. In this case, there is no need to prepare a midsole for securing cushioning properties and stability relative to the foot of the shoe wearer and an outsole for securing durability such as wear-resistance of the ground-contact surface and grip performance and also no need to connect the midsole with the outsole by gluing, fusing, and the like. According to the present embodiment, the sole body alone can function as a midsole and also an outsole.

Next, FIGS. 5 to 5D are drawings for explaining a basic module that constitutes the above-mentioned three-dimensional elastic structure, showing an example of the basic module.

Here, as a three-dimensional elastic structure, the structure is taken for example in which a resin layer with resin filament arranged in a polygonal shape on a horizontal plane are overlaid on top of each other in the vertical direction.

The basic module 50 in FIG. 5 is shown by four-layered resin layer overlaid vertically (or perpendicularly to the sheet of the drawing) in different lines (see a solid lines, a dash-and-dot line, a phantom line, and a dotted line).

The basic module 50 is composed of a first pattern 51 disposed at a topmost layer (a first layer) and shown by a solid line (see FIGS. 5, 5A), a second pattern 52 disposed at a second layer immediately adjacent and below the first layer and shown by a dash-and-dot-line (see FIGS. 5, 5B), a third pattern 53 disposed at a third layer immediately adjacent and below the second layer and shown by a phantom line (see FIGS. 5, 5C), and a fourth pattern 54 disposed at a fourth layer immediately adjacent and below the third layer and shown by a dotted line (see FIGS. 5, 5D). The first to fourth patterns 51 to 54 are formed of resin filaments (resin fibers).

As shown in FIG. 5A, the first pattern 51 has a pair of octagonal frame bodies 51a spaced away from each other and a small square frame body 52a disposed between the frame bodies 51a. Opposite sides of the frame body 52a are shared with the sides of the frame bodies 51a. As shown in FIG. 5B, the second pattern 52 has a pair of square frame bodies 51b spaced away from each other and chamfered at every apex and a square frame body 52b smaller than the square frame bodies 51b disposed between the frame bodies 51b. Opposite sides of the frame body 52b are shared with the sides of the frame bodies 51b. As shown in FIG. 5C, the third pattern 53 has a pair of square frame bodies 51c spaced away from each other and a square frame body 52c larger than the square frame bodies 51c disposed between the frame bodies 51c and chamfered at every apex. Opposite sides of the frame body 52c are shared with the sides of the frame bodies 51c. As shown in FIG. 5D, the fourth pattern 54 has a pair of small square frame bodies 51d spaced away from each other and a large octagonal frame body 52d disposed between the frame bodies 51d. Opposite sides of the frame body 52d are shared with the sides of the frame bodies 51d.

The first to fourth layers of the three-dimensional elastic structure 5 are so structured as to dispose the first to fourth patterns 51 to 54 to cover and spread in each layer. The three-dimensional elastic structure 5 is so structured as to overlay the first to fourth layers in the vertical direction and to contact and attach the vertically adjacent layers with one other via the resin filaments. Also, with regard to regions below the fourth layer, from the third pattern 53 to the second pattern 52 in order, and thereafter the first to fourth patterns 51 to 54 are repeated in ascending order and descending order.

In such a manner, in the three-dimensional elastic structure 5, thin resin filaments extend laterally and longitudinally at predetermined spaces to form each layer on the horizontal plane. Then, each layer is overlaid to be connected to each other through the filaments in the vertical (i.e. thickness) direction to constitute the three-dimensional fiber structure 5. Therefore, in every direction as well as longitudinal, lateral and vertical directions, favorable elasticity can be achieved and dramatic weight-reduction is made possible compared to prior-art materials such as EVA, rubber and the like.

Then, FIG. 6 illustrates a longitudinal sectional shape of a portion of the sole body 3 and the columnar portions 30, and FIG. 7 illustrates a cross-sectional shape of the columnar portions 30. In the respective drawings, sectional areas are shown in black. The left to right direction in FIG. 6 corresponds to the longitudinal direction of the shoe. As shown in FIGS. 6 and 7, the columnar portion 30 has for example, a cylindrical shape (or a prismatic shape such as a triangular prism shape, a quadrangular prism shape, hexagonal prism shape, and the like may be used). At the outer circumferential surface of the columnar portion 30, a plurality of protrusions 32, 32′ are provided that protrude laterally (i.e. radially outwardly). In this exemplification, the respective protrusions 32, 32′ are radially disposed approximately 45 degrees apart from each other around the perimeter of the columnar portion 30. In the respective drawings, for illustration and explanation purposes, the length of the columnar portion 30 and the size of the respective protrusions 32, 32′ are shown magniloquently. The protrusion length of the respective protrusions 32, 32′ that protrude laterally is preferably 0.2 mm or more.

As shown in FIGS. 6 and 7, the respective protrusions 32, 32′ are provided at multiple locations of the columnar portion 30 in the axial direction and the circumferential direction. That is, as shown in FIG. 6, the protrusions 32 are provided at multiple (e.g. three in FIG. 6) locations in the axial direction (or up-down direction in FIG. 6) from the proximal end side (or upper end side in FIG. 6) to the distal end side (or lower end side in FIG. 6) of the columnar portion 30. Similarly, the protrusions 32′ are provided at multiple (e.g. two in FIG. 6) locations in the axial direction (or up-down direction in FIG. 6) from the proximal end side (or upper end side in FIG. 6) to the distal end side (or lower end side in FIG. 6) of the columnar portion 30. The respective protrusions 32 are disposed at equal axial spacings along the columnar portion 30, but the spacings of the respective protrusions 32 may not be equal. Likewise, the respective protrusions 32′ may not be disposed at equal axial spacings along the columnar portion 30. In this exemplification, the axial locations of the respective protrusions 32′ are out of alignment with the axial locations of the respective protrusions 32. The respective protrusions 32′ are located between the axially adjacent respective protrusions 32, but the axial locations of the respective protrusions 32′ may not be out of alignment with the axial locations of the respective protrusions 32.

As shown in FIG. 7, the protrusion 32 are provided at multiple (e.g. eight in FIG. 7) locations along the outer circumferential surface of the columnar portion 30. Similarly, the protrusion 32′ are provided at multiple (e.g. eight in FIG. 7) locations along the outer circumferential surface of the columnar portion 30. The respective protrusions 32 are disposed at equal circumferential spacings around the outer circumferential surface of the columnar portion 30 (the same applies to the respective protrusions 32′), but the spacings of the respective protrusions 32 may not be equal (the same applies to the respective protrusions 32′). In this exemplification, the circumferential locations of the respective protrusions 32′ are out of alignment with the circumferential locations of the respective protrusions 32. The respective protrusions 32′ are located between the circumferentially adjacent respective protrusions 32. The reason why the circumferential locations of the respective protrusions 32′ are out of alignment with the circumferential locations of the respective protrusions 32 is because an interference between the respective protrusions 32′ and the respective protrusions 32 should be prevented when the columnar portion 30 tilts and bending-deforms under a load.

The number of protrusions 32, 32′ is not restricted to the above-mentioned numbers and it can be either more or less than that. Also, the respective protrusions 32, 32′ have for example, a rectangular prism shape, or a square prism shape, but the cross-sectional shape of the respective protrusions 32, 32′ is not limited to a rectangle, or square, and it can be other shapes. In either case, the distal end of the respective protrusions 32, 32′ preferably has a corner with an edge.

The bottom surface 30a of the columnar potion 30 has a ground-contact surface. The bottom surface 30a is formed with a plurality of protrusions 31 that protrude downwardly. The respective protrusions 31 have a bottom surface 31a. FIG. 6 shows the state that the bottom surface 30a of the columnar portion 30 is in contact with the ground C through the protrusions 31. In addition, these protrusions 31 may be omitted.

When molding the sole structure 2 by the above-mentioned 3D printer, the respective protrusions 31, 32, 32′ as well as sole body 3 and the columnar portions 30 are integrally formed with one another.

Next, function and effect of the present embodiment will be explained using FIGS. 8 and 9 with reference to FIGS. 6 and 7. In FIGS. 8 and 9, the left direction of the drawings designates a forward direction of the shoe, and the right direction of the drawings designates a rearward direction of the shoe.

At the time of landing of the shoe 1, when the sole body 3 impacts the ground from for example, the heel rear end, the bottom surfaces 30a of the columnar portions 30 at the heel rear end come into contact with the ground through the protrusions 31 (see FIG. 6). At this time, the bottom surface 31a of the respective protrusions 31 exhibits a grip performance relative to the ground.

Also, at the time of landing, when a shock load is applied to the heel rear end of the sole body 3, the columnar portions 30 at the heel rear end tilt and bending-deform due to this shock load. At this juncture, as shown in FIGS. 8 and 9, the distal end of the respective columnar portions 30 tilts rearwardly or forwardly, such that thereby the respective columnar portions 30 bends to fall rearwardly or forwardly.

As shown in FIG. 8, when the respective columnar portions 30 tilt rearwardly to bending-deform, the front side (or left side of the drawing) of the respective columnar portions 30 elongates elastically, whereas the rear side (or right side of the drawing) of the respective columnar portions 30 contracts elastically. To the contrary, as shown in FIG. 9, when the respective columnar portions 30 tilt forwardly to bending-deform, the rear side (or right side of the drawing) of the respective columnar portions 30 elongates elastically, whereas the front side (or left side of the drawing) of the respective columnar portions 30 contracts elastically.

Then, as shown in FIGS. 8 and 9, the protrusions 32 (and 32′) disposed on the elastically elongated side of the respective columnar portions 30 come into contact with the ground C. At this time, due to the action of the protrusions 32 (and 32′), the grip performance can be further improved during ground contact. In this case, since the protrusions 32 (and 32′) have a corner with an edge, at the time of contacting the ground, the grip by frictional resistance at the edge of the corner can be exhibited (so-called “edge-effect”), thereby further increasing grip performance.

On the other hand, as shown in FIGS. 8 and 9, the protrusions 32 (and 32′) disposed on the elastically contracted side (or right side of FIG. 8, left side of FIG. 9) of the respective columnar portions 30 come close to each other and thus the distance between the axially adjacent protrusions 32 (and also between the axially adjacent protrusions 32′) becomes shorter. Even in that case, an adequate distance is secured between the axially adjacent protrusions 32 (and also between the axially adjacent protrusions 32′), so that a mutual interference between the axially adjacent protrusions 32 (and also between the axially adjacent protrusions 32′) can be prevented. Additionally, in FIGS. 8 and 9, for illustration purposes, only the respective protrusions 32 are shown on the elastically contracted side of the respective columnar portions 30 and the respective protrusions 32′ are not shown.

After landing of the shoe 1, as the load is transferred from the heel region H through the midfoot region M to the forefoot region F of the sole body 3, the respective columnar portions 30 may make deformation shown in FIG. 8 or 9. Also, when the foot moves to the push-off phase, the forefoot region F bends largely at the metatarsophalangeal joint (i.e. MTP joint) portion. At this juncture, the respective columnar portions 30 at the metatarsophalangeal joint portion or the toe portion make deformation shown in FIG. 8 or 9.

In that case as well, as with landing on the ground, since the respective protrusions 32 (and 32′) on the elastically elongated side of the respective columnar portions 30 come into contact with ground C, due to the action of the protrusions 32 (and 32′), grip performance during landing can be further improved. Also, in this case as well, since the protrusion 32 (and 32′) has a corner with an edge at the end surface, due to a so-called “edge effect” by the edge at the corner, grip performance ca be still further enhanced. Thereby, at the time of push-off motion of the toe portion, a sufficient push-off power can be exerted to the ground C without causing a slip.

Moreover, according to the present embodiment, since the respective protrusions 32, 32′ disposed at the outer circumferential surface of the respective columnar portions 30 are arranged in the radial direction, even in the event that the tilting direction of the respective columnar portions 30 is an intersecting direction (i.e. diagonal direction/lateral direction) relative to the longitudinal direction, any of the respective protrusions 32, 32′ at the outer circumferential surface of the respective columnar portions 30 comes into contact with the ground C, such that thereby grip performance can be further improved. For example, when sidestepping during exercise, the respective columnar portions 30 tilt laterally and thus sufficient grip performance can be exhibited.

Also, according to the present embodiment, since the respective protrusions 32, 32′ are provided at the outer circumferential surface, i.e. at the side surface, and thus the respective columnar portions 30 have an undulation at the side surface. Therefore, even in the event that the bottom surface 31a of the respective protrusions 31 and the bottom surface 30a of the respective columnar portions 30 wear down through the use of the shoe 1, grip function can be maintained by falling of the respective columnar portions 30. Also, the provision of the respective protrusions 32, 32′ on the proximal-end side of the respective columnar potions 30 causes such a grip function to last for a prolonged period.

### First Alternative Embodiment

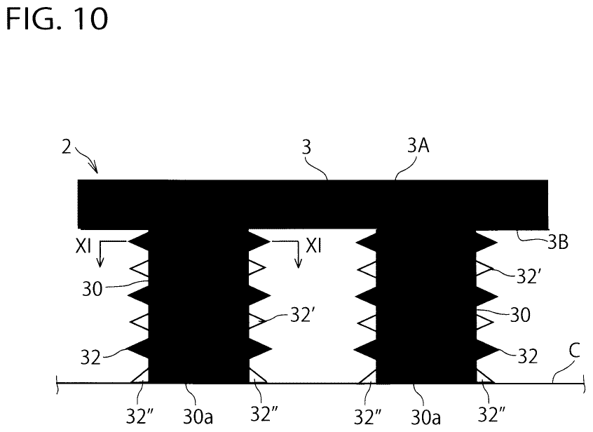

FIGS. 10 to 13 show a variant of the columnar portion according to the above-identified embodiment, corresponding respectively to FIGS. 6 to 9 of the above-identified embodiment. In these drawings, like reference numbers indicate identical or functionally similar elements to those in the above-identified embodiment.

In the above-identified embodiment, an example was shown in which the respective protrusions 32, 32′ have a rectangular prism shape or a square prism shape, and the cross-sectional shape and the longitudinal sectional shape of the respective protrusions 32, 32′ is a rectangle or a square. However, in this first alternative embodiment, the respective protrusions 32, 32′ have a triangular prism shape, and the cross-sectional shape is a rectangle or a square, whereas the longitudinal sectional shape is a triangle. Also, at the lower end of the respective columnar portions 30, there are provided a protrusion 32″ of a right triangular shape in longitudinal section. In this case as well, the distal end of the respective protrusions 32, 32′, 32″ has a corner with an edge at the distal end. Also, in the above-mentioned embodiment, a plurality of protrusions 31 are provided at the bottom surface 30a of the columnar portions 30, but in this first alternative embodiment, the protrusions 31 are omitted.

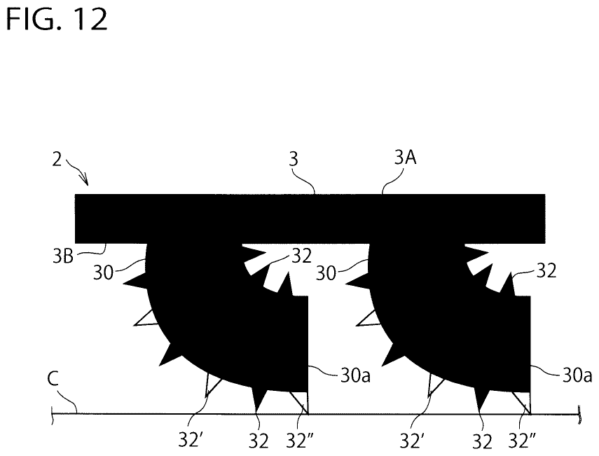

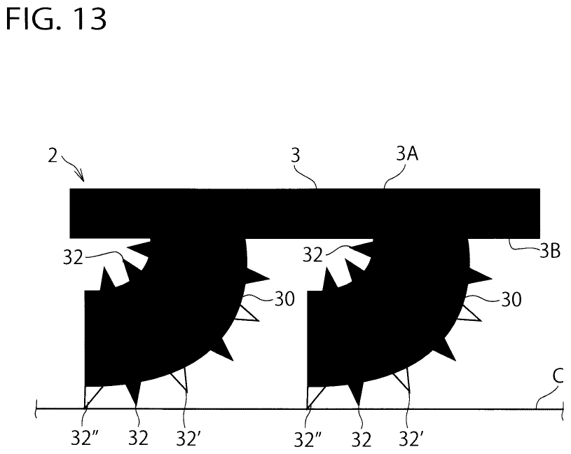

The first alternative embodiment produces a similar effect to the above-identified embodiment. That is, at the time of landing of the shoe 1, during movement of the load, and at the time of push-off motion, when the multiple columnar portions 30 tilt (or bending-deform), as shown in FIGS. 12 and 13, the distal end of the respective columnar portions 30 tilts rearwardly or forwardly, and thus the respective columnar portions 30 fall to bend rearwardly or forwardly. At this time, the protrusions 32″ (and 32, 32′) disposed on the elastically elongated side of the respective columnar portions 30 come into contact with the ground C. Then, due to the action of the protrusions 32″ (and 32, 32′), grip performance during contact with the ground can be further improved. In this case, since the protrusions 32″ (and 32, 32′) have a corner with an edge at the distal end, at the time of contacting the ground, due to a so-called “edge effect” by the edge of the corner at the distal end, grip performance can be still further improved. Thereby, at the time of push-off motion of the toe portion, a sufficient push-off power can be imparted to the ground C without causing a slip.

Additionally, in this first alternative embodiment, contrary to the above-identified embodiment, the protrusions 31 are not provided at the bottom surface 30a of the multiple columnar portions 30. FIG. 10 shows the state in which the bottom surface 30a of the columnar portions 30 (and the bottom surface of the protrusions 32″) are in direct contact with the ground C.

### Second Alternative Embodiment

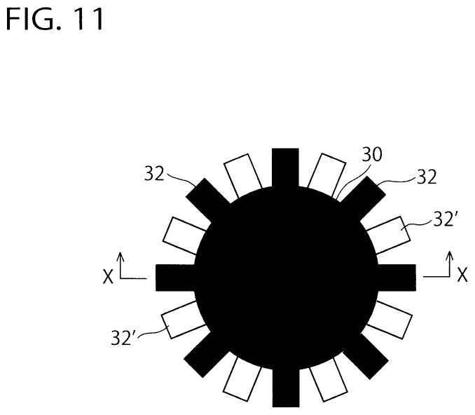

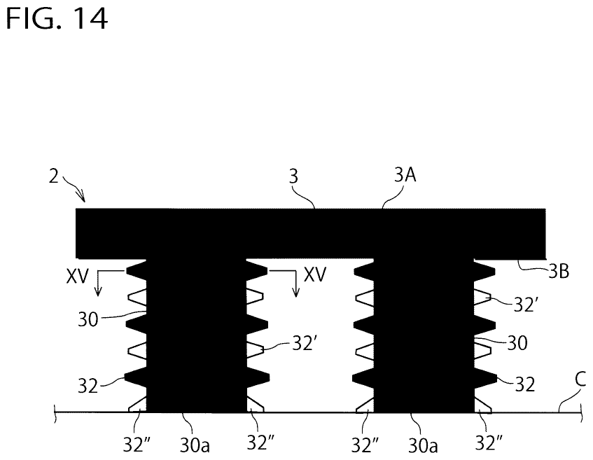

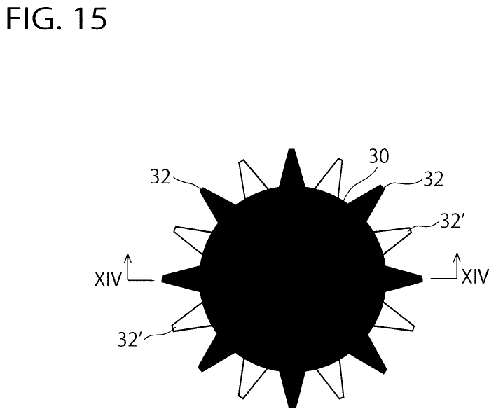

FIGS. 14 and 15 show another variant of the columnar portion according to the above-identified embodiment, corresponding respectively to FIGS. 6 and 7 of the above-identified embodiment and FIGS. 10 and 11 of the first alternative embodiment. In these drawings, like reference numbers indicate identical or functionally similar elements to those in the above-identified embodiment and the first alternative embodiment.

In the first alternative embodiment, an example was shown in which the respective protrusions 32, 32′ have a triangular prism shape and the cross-sectional shape is a rectangle or a square and the longitudinal sectional shape is a triangle, but in the second alternative embodiment, both the cross-sectional shape and the longitudinal sectional shape of the respective protrusions 32, 32′ are a trapezoid. In this case as well, the respective protrusions 32, 32′ have a corner with an edge at the distal end thereof. The second alternative embodiment as well produces a similar effect to the above-identified embodiment and the first alternative embodiment.

### Third Alternative Embodiment

In the above-mentioned embodiment and the first and second alternative embodiments, an example was shown in which a plurality of protrusions 32, 32′, 32″ that protrude laterally are provided at the outer circumferential surface of the respective columnar portions 30, but these protrusions may be created by forming a plurality of recesses at the outer circumferential surface of the respective columnar portions 30. Also, the protrusion may not be such a laterally extending portion as shown in the above-mentioned embodiment and first and second alternative embodiments, and it may be formed as a part of unevenness formed at the outer circumferential surface of the respective columnar portions 30.

Moreover, the protrusion may be a rib of a certain length in the axial direction or the circumferential direction of the respective columnar portions 30. With regard to the circumferential direction, the protrusions may be an annular portion or a ring-shaped portion, extending around the entire perimeter of the outer circumferential surface of the respective columnar portions 30. That is, in FIG. 7 of the above-mentioned embodiment, the respective protrusions 32 or 32′ may be interconnected to each other around the entire circumference.

### Fourth Alternative Embodiment

In the above-mentioned embodiment and the first to third alternative embodiments, an example was shown in which a plurality of protrusions 32, 32′, 32″ are arranged radially (or spaced approximately 45 degrees circumferentially apart from each other) at the outer circumferential surface of the columnar portions 30, but the application of the present invention is not limited to such an example. The respective protrusions 32, 32′, 32″ may be spaced approximately 90 degrees circumferentially apart from each other at the outer circumferential surface of the columnar portions 30.

### Fifth Alternative Embodiment

In the above-mentioned embodiment and the first to fourth embodiments, an example was shown in which the respective columnar portions 30 have a cylindrical shape or a prismatic shape and the size of the cross-sectional shape (e.g. circle, rectangle, etc.) is not varied in the axial direction, but the application of the present invention is not limited to such an example. The size of the cross-sectional shape (e.g. circle, rectangle, etc.) of the respective columnar portions 30 may be varied in the axial direction. That is, the respective columnar portions 30 may be tapered in the axial direction. Especially, from the proximal end side toward the distal end side of the respective columnar portions 30, the respective columnar portions 30 may be inverse-tapered (that is, the diameter or size becomes gradually larger from the proximal end side toward the distal end side). Such an inverse-tapered shape is difficult to mold by a general molding method using a mold, but the molding method using a 3D printer according to the present invention can mold such an inverse-tapered shape easily.

### Sixth Alternative Embodiment

In the above-mentioned embodiment and the first to fourth embodiments, an example was shown in which the respective columnar portions 30 are axially extending pillar member such as a member of a cylindrical shape or a prismatic shape, but the application of the present invention is not limited to such an example. As the respective columnar portions 30, a design (or a tread pattern) generally applied to the bottom surface of a shoe, for example, extending in a rib-shape or a plate-shape along the lower surface 3B of the sole body 3 may be adopted.

In that case, it is preferable that the respective columnar portions formed of the above design have an easy-to-fall shape to produce the effects of the present invention easily.

In the case of a rib-shaped design that extends along the lower surface 3B of the sole body 3, the cross-sectional shape (in the direction perpendicular to the longitudinal direction) of a trapezoidal shape (the top base with a short length is on the lower surface 3B side and the bottom base with a long length is on the ground contact surface side) may be adopted to cause the respective columnar portions to fall easily at the time of landing.

Also, in the case of a plate-shaped design that extends along the lower surface 3B of the sole body 3, such a design may intersect in a V-shape on the lower surface 3B of the sole body 3, and the sidewall surface of the respective designs may be an inclined surface, thereby causing the respective designs to fall easily at the time of landing.

In the above-mentioned respective embodiments and alternative embodiments, an example was shown in which the sole structure of the present invention is applied to a running shoe, but the application of the present invention is not restricted to such an example. The present invention is also applicable to other sports shoes such as a walking shoe, soccer shoe, and the like, and to shoes other than a sport shoe.

As mentioned above, the present invention is useful for a sole structure of a shoe that can further improve grip performance.

Those skilled in the art to which the invention pertains may make modifications and other embodiments employing the principles of this invention without departing from its spirit or essential characteristics particularly upon considering the foregoing teachings. The described embodiments and examples are to be considered in all respects only as illustrative and not restrictive. The scope of the invention is, therefore, indicated by the appended claims rather than by the foregoing description. Consequently, while the invention has been described with reference to particular embodiments and examples, modifications of structure, sequence, materials and the like would be apparent to those skilled in the art, yet fall within the scope of the invention.

What is claimed is:

1. A sole structure for a shoe, said sole structure comprising a longitudinally extending sole body,
wherein said sole body includes a plurality of columnar portions that are provided at a lower surface of said sole body,
wherein a bottom surface of said respective columnar portions has a ground-contact surface and an outer circumferential surface of said respective columnar portions has a plurality of laterally extending protrusions.

2. The sole structure according to claim 1, wherein at the time of loading said columnar portions tilt in such a way that said protrusions contact the ground.

3. The sole structure according to claim 1, wherein said plurality of protrusions are provided axially and circumferentially at a proximal-end side to a distal-end side of said columnar portions.

4. The sole structure according to claim 1, wherein a distal end of said protrusions has a corner with an edge.

5. The sole structure according to claim 1, wherein an upper surface of said sole body constitutes a foot-sole-contact surface that a foot sole of a shoe wearer contacts directly or indirectly through an insole,
Wherein said sole body has functions as both a midsole that imparts cushioning properties to a foot of the shoe wearer and an outsole that contacts the ground.

6. The sole structure according to claim 1, wherein said sole body is integrally formed with said columnar portions and said protrusions.

7. The sole structure according to claim 1, wherein said sole structure is formed by an additive manufacturing through a 3D printer.

8. The sole structure according to claim 7, wherein said 3D printer is a fused-deposition-modeling type.
